(19) United States
(12) Patent Application Publication
(10) Pub. No.: US 2019/0327198 A1
(43) Pub. Date: Oct. 24, 2019

(54) MESSAGING APPARATUS, SYSTEM AND METHOD

(71) Applicant: DOOEY LIMITED, Glasgow (GB)

(72) Inventor: John Hugh CONNOR, Glasgow (GB)

(21) Appl. No.: 16/464,986

(22) PCT Filed: Nov. 17, 2017
(86) PCT No.: PCT/GB2017/053471

§ 371 Date: May 29, 2019

(30) Foreign Application Priority Data
Nov. 30, 2016 (GB) 1620273.1

(51) Int. Cl. H04L 12/58

(52) U.S. Cl. CPC H04L 51/16; H04L 51/32; H04L 51/22

(57) ABSTRACT

A method of sending and receiving messages organized in threads, the method includes receiving messages posted by a group of one or more users to at least one message thread and posting messages to the at least one message thread for access by the group of users, the messages being sent to and received from a message server; displaying messages posted by one or more users of the group of users to the at least one message thread; receiving a user selection of a message in a parent message thread for the creation of a child message thread, the message having a message identifier; receiving a new message to post to the child message thread; posting the new message by sending the new message to the message server to be accessible by the group of users in the child message thread; creating or receiving a link between the message identifier for the selected message in the parent message thread and a new message identifier for the new message in the child message thread; and displaying the new message in the child message thread.

### FIELD OF THE INVENTION

The present invention relates to a messaging apparatus and method for communicating messages between users.

### BACKGROUND INFORMATION

The way in which humans interact with digital electronic devices is a major factor in the efficiency of the technical functioning of the device. The effectiveness of digital electronic devices can be drastically reduced if they are not easy to use. Designers and manufacturers therefore expend a great deal of effort in designing intuitive user interfaces that can display information to users and enable them to interact by making selections and entering data easily.

The use of electronic devices for communicating messages between users has become prevalent in modern society. Mobile communications devices such as mobile telephones or so-called smart phones have become ubiquitous and hence communications between users of these devices is an important functionality. The use of email communications, whilst still significant, is being overtaken by other forms of messaging such as instant messages, where messages are sent near instantly from a sender to a group of users and can be linked as a sequence of messages in a message thread.

It is important in messaging applications that messages should be easy to identify and respond to in the user interface.

### SUMMARY OF THE INVENTION

One aspect provides a messaging apparatus for sending and receiving messages organised in threads, the messaging apparatus comprising a communications interface to receive messages posted by a group of one or more users to at least one message thread and to post messages to the at least one message thread for access by the group of users, the communications interface being adapted to send the messages to and received the messages from a message server; a display to display messages posted by one or more users of the group of users to the at least one message thread; a user input device to receive a user selection of a message in a parent message thread for the creation of a child message thread, the message having a message identifier, the user input device being adapted to receive a new message to post to the child message thread; and a message processor to post the new message by controlling the communications interface to send the new message to the message server to be accessible by the group of users in the child message thread, the message processor being adapted to create or receive a link between the message identifier for the selected message in the parent message thread and a new message identifier for the new message in the child message thread; wherein the display is adapted to display the new message in the child message thread.

Another aspect provides a method of sending and receiving messages organised in threads, the method comprising receiving messages posted by a group of one or more users to at least one message thread and posting messages to the at least one message thread for access by the group of users, the messages being sent to and received from a message server; displaying messages posted by one or more users of the group of users to the at least one message thread; receiving a user selection of a message in a parent message thread for the creation of a child message thread, the message having a message identifier; receiving a new message to post to the child message thread; posting the new message by sending the new message to the message server to be accessible by the group of users in the child message thread; creating or receiving a link between the message identifier for the selected message in the parent message thread and a new message identifier for the new message in the child message thread; and displaying the new message in the child message thread.

Another aspect provides a messaging apparatus for viewing messages organised in threads, the messaging apparatus comprising a communications interface to receive messages posted by a group of one or more users to message threads, the communications interface being adapted to receive the messages from a message server, the message threads including a parent message thread and a child message thread and a link between a message identifier for a message in the parent message thread and a message identifier for a message in the child message thread; a display to display messages posted by one or more users of the group of users to the message threads; a user input device to receive a user navigation input to navigate the displayed messages in the message threads; and a message processor to receive user navigation input from the user input device to allow a user to navigate displayed messages from the parent message thread and the child message thread using said link between the message identifiers.

Another aspect provides a method of viewing messages organised in threads, the messaging method comprising receiving messages posted by a group of one or more users to message threads from a message server, the message threads including a parent message thread and a child message thread and a link between a message identifier for a message in the parent message thread and a message identifier for a message in the child message thread; displaying messages posted by one or more users of the group of users to the message threads; receiving a user navigation input to navigate the displayed messages in the message threads; and receiving user navigation input from the user input device to allow a user to navigate displayed messages from the parent message thread and the child message thread using said link between the message identifiers.

Another aspect provides a system for configuring a client device as a messaging apparatus having a communications interface, a display device, a user input device and a message processor, the system comprising a processor; and a network interface adapted to be controlled by the processor to transmit computer program code to the client device to cause the client device to be configured as the messaging apparatus as outlined above.

Another aspect provides a method of configuring a client device as a messaging apparatus having a communications interface, a display device, a user input device and a message processor, the method comprising transmitting computer program code to the client device to cause the client device to be configured as the messaging apparatus as outlined above.

A further aspect provides a carrier medium carrying processor implementable code for controlling a processor to carry out a method of sending and receiving messages organised in threads and a method of viewing messages organised in threads as outlined above.

### BRIEF DESCRIPTION OF THE DRAWINGS

FIG. 1 is a schematic diagram illustrating an apparatus according to one embodiment;

FIG. 2 is a schematic diagram illustrating the apparatus of FIG. 1 in more detail according to one embodiment;

FIG. 3 is an illustration of a display of an apparatus displaying parent message threads according to one embodiment;

FIG. 4 is an illustration of a display of an apparatus displaying messages of a selected parent message thread according to one embodiment;

FIG. 5 is an illustration of a display of an apparatus displaying messages of a parent message thread with one message selected according to one embodiment;

FIG. 6 is an illustration of a display of an apparatus displaying messages of a parent message thread with one message selected and the information option selected for the selected message according to one embodiment;

FIG. 7 is an illustration of a display of an apparatus displaying messages of a parent message thread with one message selected and the result of a selection of the option to create a new branch or child thread according to one embodiment;

FIG. 8 is an illustration of a display of an apparatus displaying an initial state of a display for the creation of a new branch or child thread and the input of a new message for the thread according to one embodiment;

FIG. 9 is an illustration of a display of an apparatus displaying messages of a branch or child thread according to one embodiment;

FIG. 10 is an illustration of a data structure for linking messages in message threads according to one embodiment;

FIG. 11 is an illustration of a data structure for linking messages in message threads in which the structure has more than two levels in a hierarchical arrangement according to one embodiment; and

FIG. 12 is a flow diagram illustrating the process of message entry and viewing according to one embodiment.

### DETAILED DESCRIPTION

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

In the following embodiments, like components are labelled with like reference numerals.

The functions or algorithms described herein are implemented in hardware, software or a combination of software and hardware in one embodiment. The software comprises computer executable instructions stored on computer readable media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, server, a router, or other device capable of processing data including network interconnection devices.

Some embodiments implement the functions in two or more specific interconnected hardware modules with related control and data signals communicated between and through the modules, or as portions of an application-specific integrated circuit. Thus, the exemplary process flow is applicable to software, firmware, and hardware implementations.

A generalized embodiment of a messaging apparatus and method will now be described.

Messages exchanged between users can be started with an initial message and followed by subsequent messages for a message thread that follows a timeline of the exchange of messages. A user wanting to send a message will enter a message on their user device and send it or post it to a remote server over a network. Recipients of the message are users in a group such as friends in a social network or colleagues in a business network. Examples of messages are instant messages and chat.

During an exchange of messages in a thread, the topic of the thread can change considerably. It may be desirable for a user therefore to start a new thread, either with the same group of users or with a subset of the group of users. Once method could be to simply set up a completely new message thread for the new message exchange. This thread can be linked to the existing thread. However, this method does not give the users in a new message thread any information from the other message thread. This information can provide very useful context as to how the current topic of the message thread was arrived at. This is particularly the case when the topic of discussion changed considerably from the topic of an initial message in the original message thread, since the only way a user can find this out is to identify the related prior message thread and scroll through the messages to try to identify the messages at the date and time that might have triggered the reason for the new message thread.

The technical inadequacy is ameliorated in one embodiment by the linking of a message in one message thread that caused the user to and to start or branch off a new message thread with a message in a new message thread. This linking at a message level rather than at a message thread level between message threads enables a user to organize, manage and navigate message threads with context based on the information in a message in a parent message thread as a catalyst for a new message thread. Thus, this method enables a new message thread to be branched off from any point in a message thread to create a sub or child message thread.

In one embodiment each message has a unique identifier and each message thread has a unique identifier and the message level linking between message threads is achieved using a link between a message identifier for a parent message thread and a message thread identifier for a child message thread, where the child messages are linked to the child message thread by links between the child message identifiers and the child message thread identifier.

The links between the messages or the messages and the message threads can be created at the user's device or at a remote server if the message selection by the user is communicated to the remote server. The messages, message thread data, message identifiers and message thread identifiers can be stored at a remote service such as a messaging server providing a messaging function to the users. To avoid communication and network latency issues, the user's device can store a copy of the information which can be regularly synchronised with the information at the server.

In one embodiment, child message threads can be created based on messages in child threads i.e. a child message thread can become a parent message thread. Hence, the structure of the relationships between the message threads can become hierarchical with the relationships between parent and child message threads defined as links between a message in the parent message thread and either the first message in a child thread or the child message thread identifier. There can be multiple parent or root message threads, each with a hierarchical structure of sub message threads organised from them from messages in the parent message threads and child message threads.

Due to the structure created by the linking at the message level, a user's device can display messages in a thread and can receive user input selections to navigate along a message threat to a link with another message thread. The available links from messages in a currently displayed message thread to messages in a parent or child message thread can be identified in the displayed messages as a selectable link. For examples, a user can look back at prior messages in a child message thread to reach the first message and then to traverse to the message in the parent message thread that prompted a user to create the child message thread or branch. This can provide useful context information to the user.

In one embodiment, branches or child message threads can be created from any prior message in a parent message thread. A new child message thread need not just be created from the most recent message in a parent message thread.

Embodiments can be applied to a user apparatus having a display and any form of user input device, such as a pointer device (mouse, trackpad, trackerball, pen device), gesture input device, motion and/or orientation sensors, or a haptic input device (a touch sensitive input device), such as a touch pad and touchscreen that can be operated by use of a user's digit or by a stylus or pen. Hence, the input device and the display can be separate or combined. A touch sensitive input device operates particularly

One embodiment is particularly suited to a user mobile device, such as a mobile telephone, in which users tend to operate a touch screen of the device using their thumbs.

In one embodiment, a method of sending and receiving messages organised in threads, the method comprises receiving messages posted by a group of one or more users to at least one message thread and posting messages to the at least one message thread for access by the group of users, the messages being sent to and received from a message server; displaying messages posted by one or more users of the group of users to the at least one message thread; receiving a user selection of a message in a parent message thread for the creation of a child message thread, the message having a message identifier; receiving a new message to post to the child message thread; posting the new message by sending the new message to the message server to be accessible by the group of users in the child message thread; creating or receiving a link between the message identifier for the selected message in the parent message thread and a new message identifier for the new message in the child message thread; and displaying the new message in the child message thread.

In one embodiment, the user selections are received to allow a user to navigate displayed messages from the parent message thread and the child message thread using said link between the message identifiers.

In one embodiment, the content of the selected message is displayed in the parent thread as a first message of the child thread.

In one embodiment, the child message thread is created by sending to the message server a request for a new message thread to be created with the new message and receiving the child thread identifier and a new message identifier.

In one embodiment, the parent message thread has a parent message thread identifier and the child message thread has a child message thread identifier; the link between the message identifier for the selected message in the parent message thread and the new message identifier for the new message is created or received by creating or receiving a link between the message identifier for the selected message in the parent message thread and the child message thread identifier associated with the new message; and the method including storing the links between the child thread identifiers and the message identifiers of the parent message threads identifiers.

In one embodiment, the method includes receiving a user selection of a message in a child message thread for the creation of a further child message thread, the child thread identifier becoming a parent thread identifier for the further child message thread and the message having a message identifier; receiving a new message to post to the further child message thread, the further child message thread having a further child message thread identifier; creating or receiving a link between the further child thread identifier and the child thread identifier and message identifier for the selected message; posting the new message by sending the new message to the message server to be accessible by the group of users in the further child message thread; and displaying the new message in the further child message thread.

In one embodiment, the method includes storing the links between the child thread identifiers and the message identifiers of the parent message threads and the parent message thread identifiers in a hierarchically organised relationship.

In one embodiment, the method includes displaying messages of the child message thread and a navigable link to a message in the parent message thread having a message identifier linked to the child thread identifier, receiving a user selection to navigate to the message in the parent message thread having a message identifier linked to the child thread identifier, and displaying the messages of the parent message thread at a position in the parent message thread of the message having a message identifier linked to the child thread identifier.

In one embodiment, the method includes displaying messages of the parent message thread with a link to a child message thread from a message, receiving a user selection of the message in the parent message thread to navigate to the messages in the child message thread, and displaying the messages of the child message thread.

In one embodiment, the method includes receiving an input to restrict access to messages posted in a child message thread, and sending information to the message server to restrict access to the messages of the child message thread to a sub-group of users.

In one embodiment, the method includes receiving an input to change or input an image or icon to be displayed with the messages posted to a child thread.

In one embodiment, the method includes receiving an input to select a said group of users to access and share posted messages from a plurality of groups of users, each group of users being associated with a persona of the user.

In one embodiment, a method of viewing messages organised in threads, the messaging method comprises receiving messages posted by a group of one or more users to message threads from a message server, the message threads including a parent message thread and a child message thread and a link between a message identifier for a message in the parent message thread and a message identifier for a message in the child message thread; displaying messages posted by one or more users of the group of users to the message threads; receiving a user navigation input to navigate the displayed messages in the message threads; and receiving user navigation input from the user input device to allow a user to navigate displayed messages from the parent message thread and the child message thread using said link between the message identifiers.

In one embodiment, the parent message thread has a parent message thread identifier and the child message thread has a child message thread identifier;

the link between the message identifier for the selected message in the parent message thread and the new message identifier for the new message comprises a link between the message identifier for the message in the parent message thread and the child message thread identifier; and the method includes storing the links between the child thread identifiers and the message identifiers of the parent message threads identifiers.

In one embodiment, a server system can be connected to the user's device over a communication system or network such as the internet to provide code for implementation by the user's device to configure the user's device as the messaging apparatus. The code can be provided as a downloadable application or ‘app’ from a server hosting downloadable apps as is known in the art.

One embodiment provides a server apparatus for sending and receiving messages to and from user's messaging apparatuses, the server apparatus comprising a communications interface to receive messages posted by a group of one or more users to at least one message thread and to post messages to the at least one message thread for access by the group of users, the communications interface being adapted to send the messages to and receive the messages from the user's messaging apparatuses; a message processor to receive a new message from a user's messaging apparatus to be posted to be accessible by the group of users in a child message thread, the message processor being adapted to create a link between a message identifier for the selected message in a parent message thread and a new message identifier for the new message in the child message thread or receive from the user's messaging device a link between a message identifier for the selected message in a parent message thread and a new message identifier for the new message in the child message thread; and a store to store the link; wherein the communications interface is adapted to send the link to the user's messaging apparatuses to enable display of a link between a child message thread and a message in a parent message thread.

In one embodiment, the communications interface is further connected to a message server and is adapted to receive messages from the message server posted by a group of one or more users to at least one message thread and to post messages to the message server to the at least one message thread for access by the group of users, and the message processor being adapted to create the child message thread by sending to the message server a request for a new message thread to be created with the new message and to receive the child thread identifier and a new message identifier.

One embodiment provides a method sending and receiving messages to and from user's messaging apparatuses, the method comprising receiving messages posted by a group of one or more users to at least one message thread and posting messages to the at least one message thread for access by the group of users, the messages being sent to and received from the user's messaging apparatuses; receiving a new message from a user's messaging apparatus to be posted to be accessible by the group of users in a child message thread; creating a link between a message identifier for the selected message in a parent message thread and a new message identifier for the new message in the child message thread, or receiving from the user's messaging device a link between a message identifier for the selected message in a parent message thread and a new message identifier for the new message in the child message thread; storing the link; and sending the link to the user's messaging apparatuses to enable display of a link between a child message thread and a message in a parent message thread.

In one embodiment, the messages are received from a message server posted by a group of one or more users to at least one message thread and the messages are posted to the message server to the at least one message thread for access by the group of users, and the child message thread is created by sending to the message server a request for a new message thread to be created with the new message and receiving the child thread identifier and a new message identifier.

The messaging device in the embodiments can comprise any digital electronic apparatus used by a user, such as a personal computer, laptop, desktop, tablet computer, personal digital assistant, smart phone, or any other digital electronic processing device.

Specific embodiments will now be described with reference to the figures.

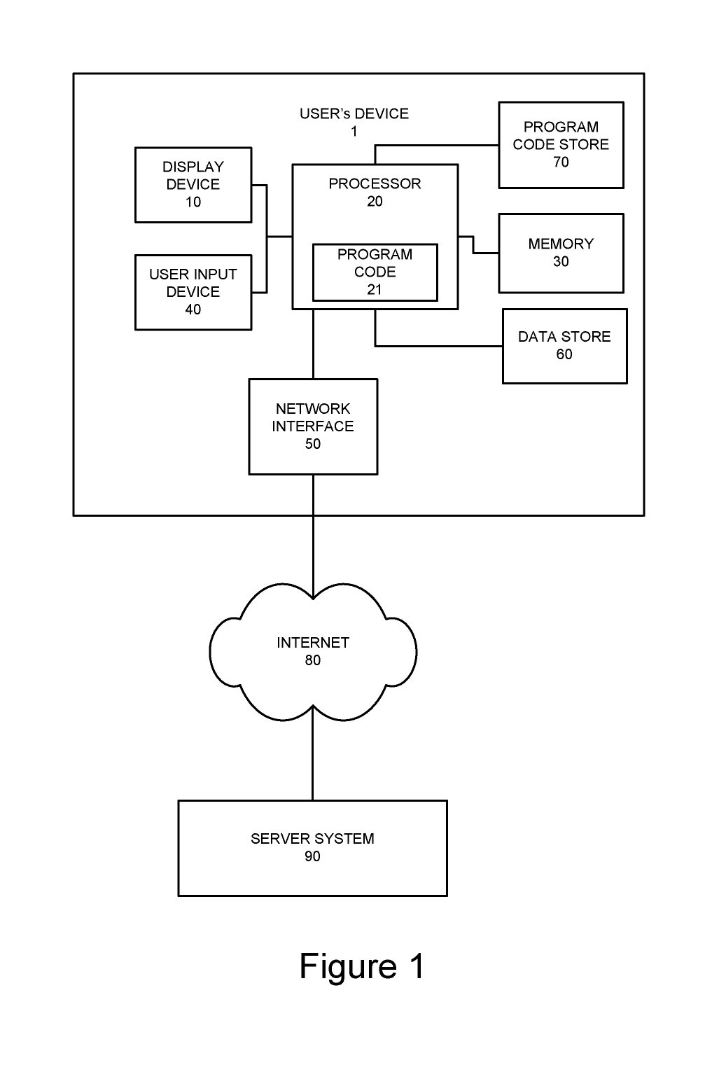

FIG. 1 is a schematic diagram of a messaging system according to one embodiment.

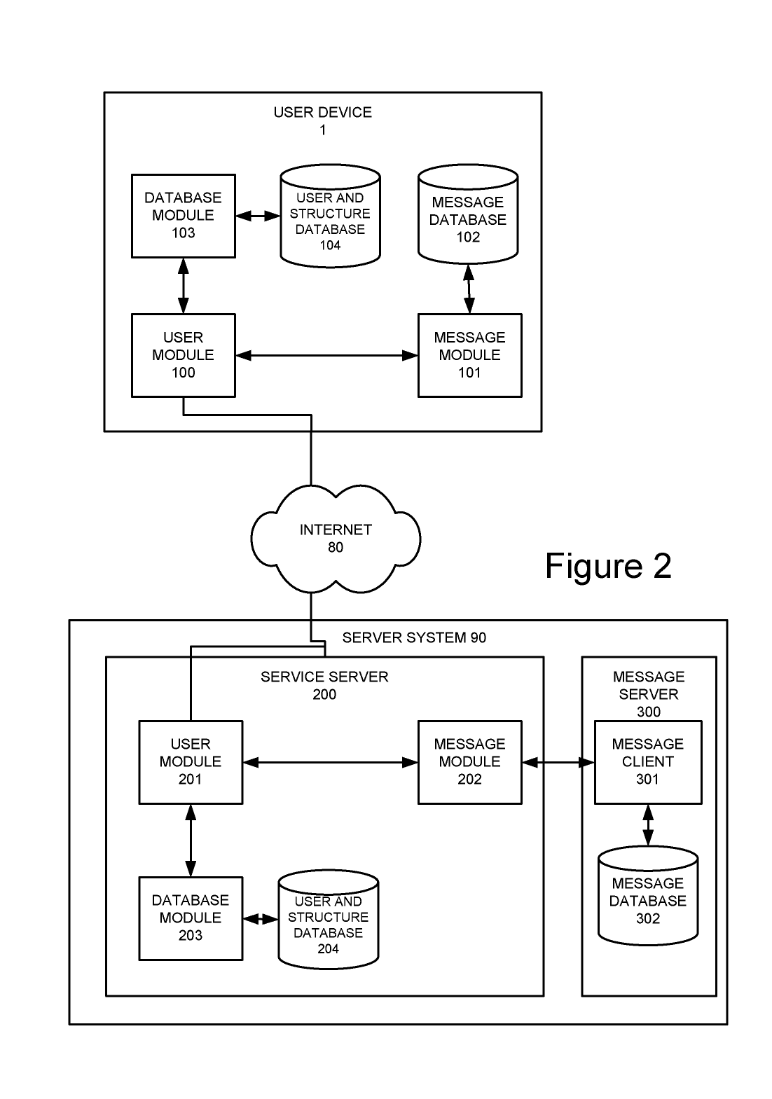

A user's device 1 can comprise a smart phone, tablet, laptop or any other device capable of connecting remotely to a network such as the internet 80. The user's device 1 includes a network interface 50 for connecting the user's device 1 to the internet 80. The network interface 50 can use any known form of network connection including a wired or wireless connection such as an Ethernet connection, a Wi-Fi connection, a near field wireless connection, a Bluetooth connection, or a mobile telephone connection such as 3G or 4G. A processor 20 within the user's device 1 reads program code from a program code store 70 and executes the code. In this embodiment, the program code 21 being executed includes a user module, a messaging module or processor and a database module as will be described in more detail with reference to FIG. 2 herein after. A volatile memory 30 is provided as working memory for use by the processor 20 during its operation. A data store 60 is provided for use by the processor 20 in storing data in the user's device 1. Such data can comprise message data and user and structure data. The details of the data will be described in more detail hereinafter.

The user's device 1 is also provided with a display device 10 to display messages and settings and a user input device 40 to enable the customer to enter messages, selection options and create new linked child message threads or branches from a current message thread. The user input device 40 can comprise any form of user input device such as a pointing device e.g. mouse, pen pad or trackpad, or a touch sensitive device such as a touch screen. The display device 10 and the user input device 40 can comprise a combined touch sensitive display.

The user's device 1 connects over the internet 80 to a remote server system 90 hosting the messaging service.

FIG. 2 illustrates the messaging system of FIG. 1 in more detail according to one embodiment.

The user's device 1 implements the program code 21 to execute a user module 100, a message module or processor 101, and a database module 103. The data store 60 stores data in the form of a message database or data store 102 and a user and structure database or data store 104.

The message module 101 operates to manage messages in the database 102 so as to make them available for display on the display device 10. The messages stored in the message database 102 are a copy of some of the messages associated with the user that are stored in the message database 302 at the message server 300. The message database 302 at the message server 300 stores message associated with multiple users. Thus, the messages stored in the message database 102 is a subset of the messages stored in the message database 302. A local copy of the messages is stored and synchronised so as to reduce the reliance on a high speed network connection i.e. to avoid latency issues.

The database module 103 operates to manage the user and structure database 104 that stores user data and link data linking the messages between parent and child message threads. The data in the user and structure database 104 is a copy of a subset of the data stored in the user structure database 204 at the service server 200. The data stored in the user and structure database 104 is specific to the user, whereas the data stored in the user and structure database 204 is for all users. Thus, the data stored in the user and structure database 104 is a synchronised copy of a subset of the data stored in the user and structure database 204. A local copy of the data is stored and synchronised so as to reduce the reliance on a high speed network connection i.e. to avoid latency issues.

The server system 90 is composed, in this embodiment, of a service server 200 and a message server 300. These servers 200 and 300 can be provided in any logical location and connected by any communication or connection arrangement, e.g. the internet, a local area network or a wide area network.

The message server 300 includes a message client 301 and a message database 302. The message database 302 stores data for all messages in all the message threads for all the users. The message server provides a convention messaging service to act in the background behind the operation of the service server 200.

The service server 200 comprises a user module 201, a message module 203, a database module 203 and a user and structure database 204. The user module connects to the user's device 1 over the internet 80 and coordinates the receiving and sending of messages to and from the message module 202, which interfaces with the message server 300 and the retrieval and storage or user data and link data by the database module 203 in the user and structure database 204.

For a user the user profile data stored in the user and structure database 104 (and copied in the user and structure database 204 at the service server 200) comprises:
A unique user ID
Name, age, etc
Location information
A profile ID for each persona of the user e.g. social and business

For each profile the data comprises:
Profile ID
Profile name
Contact details of a group of users
Picture
Biography

The use of different profiles allows a user to use the messaging system for different purposes e.g. social and business, where different contacts may be required and the user may wish to project different personas.

The structure data stored in the user and structure database 104 (and copied in the user and structure database 204 at the service server 200) for each message thread of a plurality of message threads comprises:
Unique message thread ID
Parent thread ID
Parent message ID

The message data stored in the message database 302 at the message server 300 for all the messages for all the users comprises:

For each message thread:
Message thread ID
Name of message thread
User IDs of message thread members
Picture or icon for the message thread

For each message:
Message ID
Message thread ID to which the message belongs
Message content

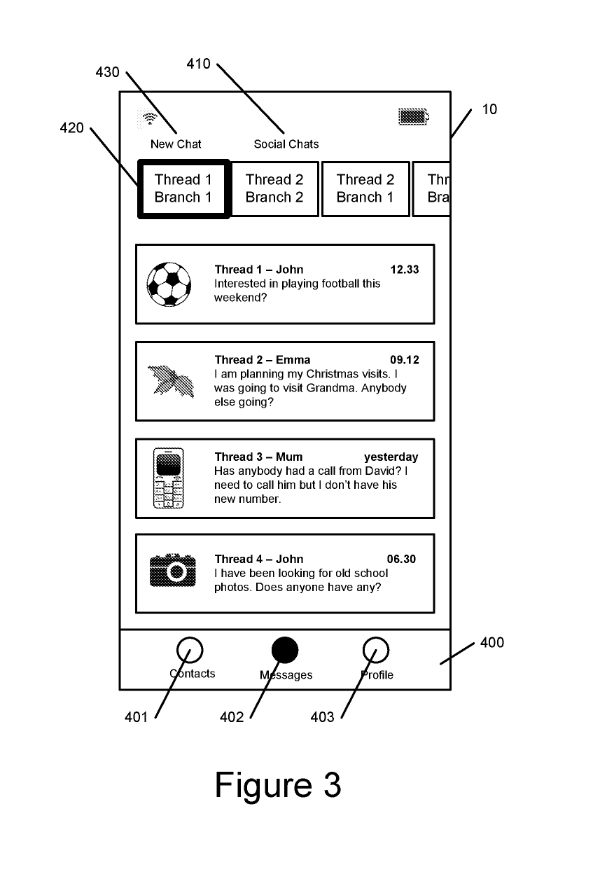

The operation of the messaging system will now be described with reference to FIGS. 3 to 12.

FIG. 3 illustrates a display screen on the display device 10 according to one embodiment. The user has opened the app running on the user's device 1 and has selected the message display screen by selecting a messages button 402 in a toolbar region 400 of the display. The user has selected a persona entitled “Social Chats” as identified by the Social Chats heading 410. The user's device is thus in a messaging mode where it enables a user to communicate with a group of users defined in the social persona in the user and structured database 104.

The display screen of FIG. 3 is the first screen that is displayed when the user selects the messages button 402. In an upper region of the display screen a scrollable list of message branches 420 having the most recent messages is displayed in order of age from left to right with the branch with the newest message at the left. Thus branch 1 of the parent or root message thread 1 contains the most recent message, branch 2 of root or parent message thread 2 has the next most recent message, branch 1 of the root or parent message thread 2 has the next most recent message, and so on. Branches that have unread messages are highlighted in the scrollable list. Thread 1 Branch 1 is illustrated highlighted in FIG. 3 in this manner.

In the main central region of the display screen the most recent messages on parent or root threads are displayed. There are 4 parent message threads illustrated in the embodiment of FIG. 3. The latest message in parent 2 relates to Christmas, the latest message in parent message thread 3 relates to contact with a person David, and the latest message in parent message thread 4 relates to school photos. As is known in the art for messages in a message system, the messages contain information on the time and date of the message and the sender. The message system also allows a user to add an image or icon to the message thread so that each message in the message thread contains the image or icon. This can assist a user in identifying messages relevant to their interests.

To create a new parent or root message thread a user can selection the New Chat option 430. The user can then enter a first message in the parent message thread, they can set the users who the message thread is to be viewed by as the set of their contacts or a subset, and they can assign an image or icon to the message thread.

If a user wishes to view or amend the users that they have in their contact data, the user can select the contacts button 401 in the toolbar on the display screen to view and modify the data for their contacts.

If a user wishes to modify their personal data, they can select the profile button 403 in the toolbar 400 on the display screen to view and modify their profile data. A user can create a new profile for a persona and modify the data of a profile.

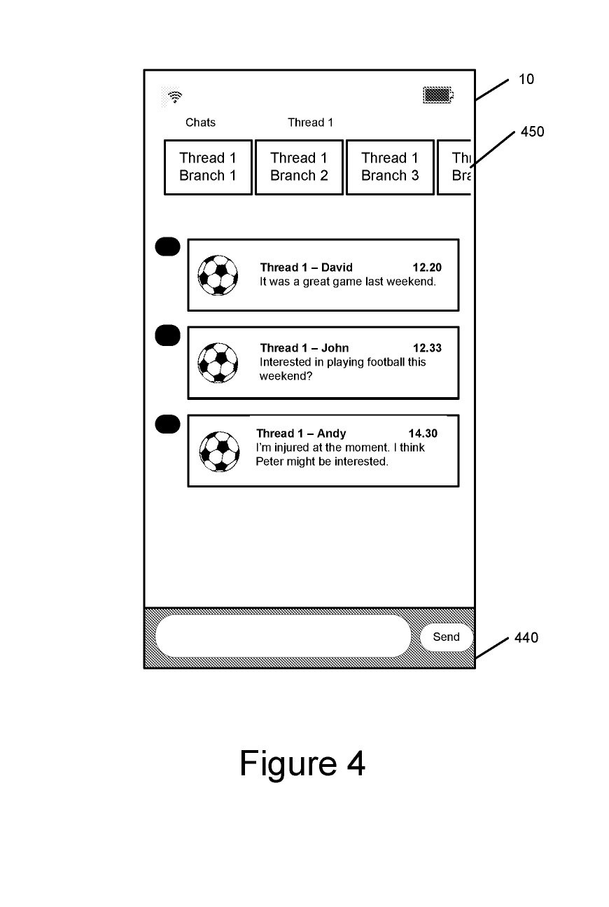

FIG. 4 illustrates the display screen displayed by the display device 10 in response to a user selection of the parent thread 1 message relating to football. The heading on this display screen states the name of the message thread, in this case Thread 1. A scrollable list 450 of branches available from this current thread is displayed in a top region of the screen display. In this embodiment there are four branches or child message threads from the current parent thread (the fourth branch option being partly off the screen display). In the main central region of the display screen the most recent messages in selected current parent or root thread are displayed. There are three recent messages illustrated in the embodiment of FIG. 4, with the last message added by another user and received by the user's device 1 after the user has selected to display the message thread 1. In a lower region of the display screen is displayed a message input region 440 for the input of a new message by the user.

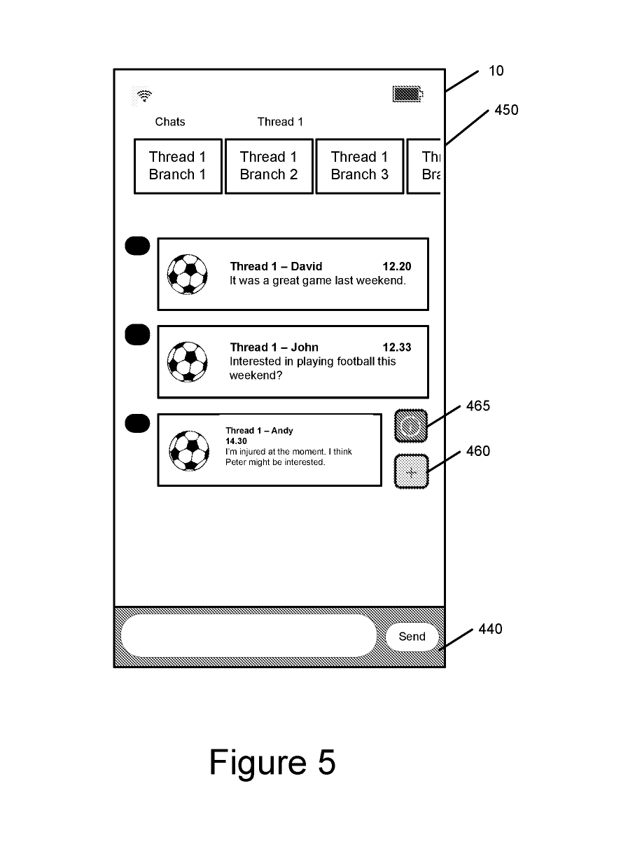

FIG. 5 illustrates the screen displayed by the display device 10 in response to the selection of the last message in the message thread, Thread 1. As can be seen in FIG. 5, the size of the message area to display the message is reduced slightly to enable two buttons to be displayed next to the selected message. One button is an information button 465 and the other is a branch triggering button 460.

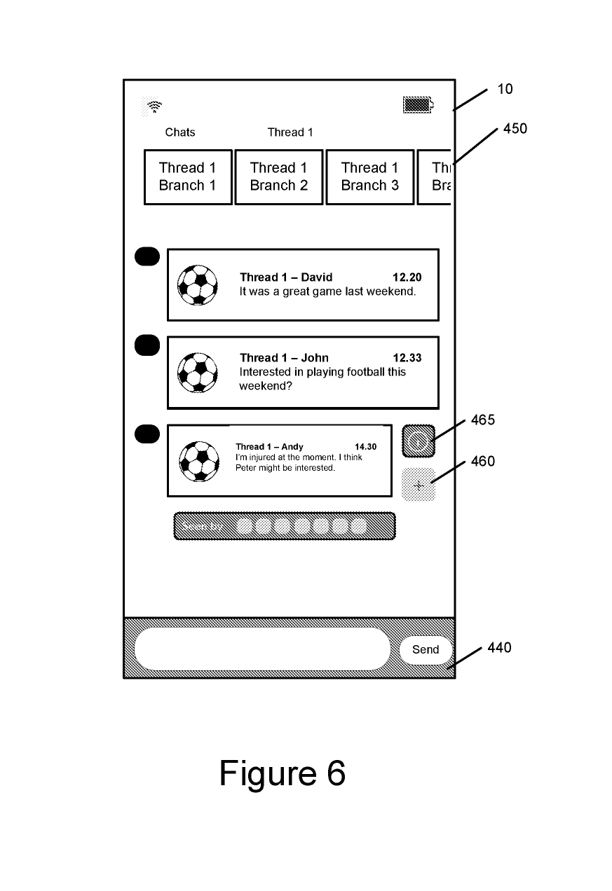

FIG. 6 illustrates the screen displayed by the display device 10 in response to the selection of the information button 465. The branch triggering button 460 is greyed out to indicate that it is not active and below the message is a list of indicators to indicate the number of users that have viewed the message.

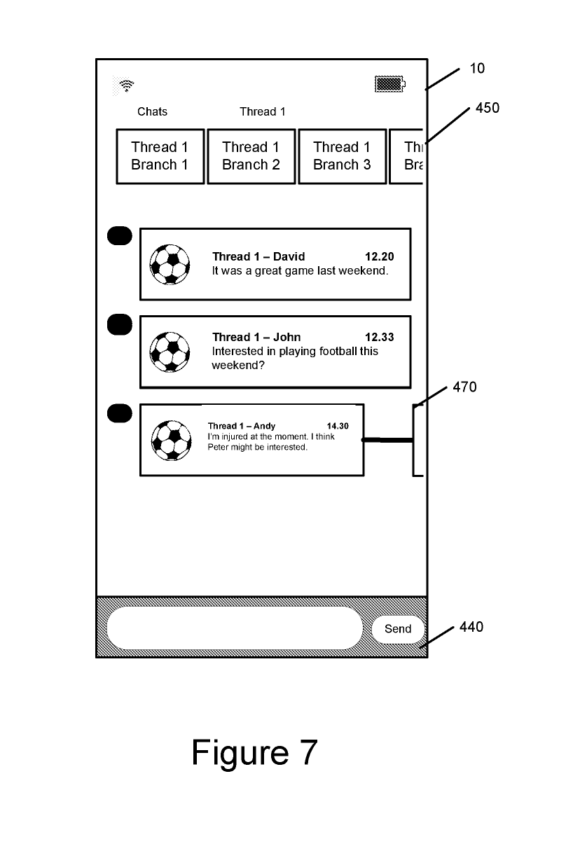

FIG. 7 illustrates the screen displayed by the display device 10 in response to the selection of the branch triggering button 460. A branching to initiate a new child message thread is initiated and the link to the branch or new child message thread is indicated as a displayed selectable link 470. In this embodiment the link can be selected by a swiping action on the touch screen display. However, any suitable link selection action can be made.

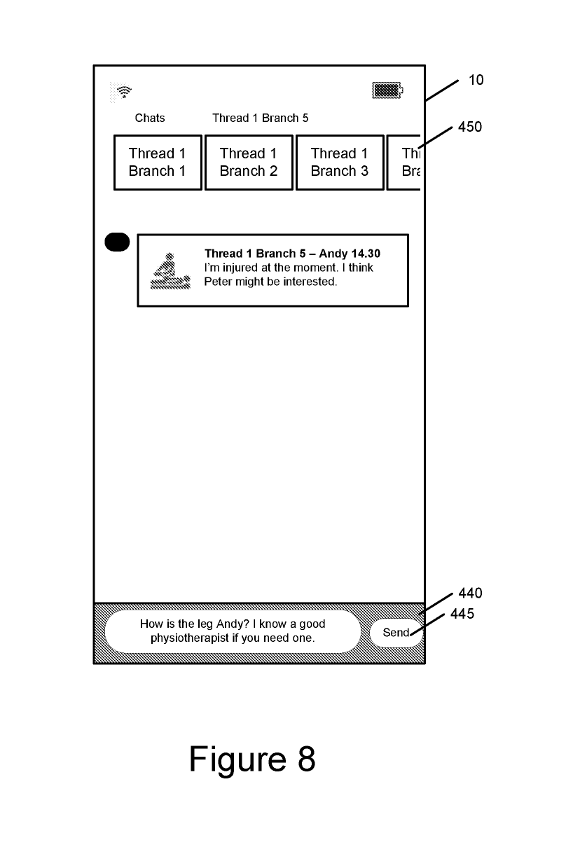

FIG. 8 illustrates the screen displayed by the display device 10 in response to the selection of the selectable link 470 in the display of FIG. 7. A new message thread in the form of a branch or child message thread is created linked to the selected message in the parent thread, Thread 1. The thread can be assigned a name by receiving input from the user or by automatically using text terms extracted from the selected message. The message thread name is indicated in FIG. 8 by its relationship to the parent thread i.e. Thread 1 Branch 5. It is the fifth branch from thread 1. The request to create a new thread is in this embodiment sent to the message server 300 for the assignment of a unique thread ID. The first message in the new branch message thread is copied from the selected message. In one embodiment, the displayed message is a displayed copy of the selected message and copy of the message is created in the new branch thread. Instead a link is simply kept to the message in the parent thread. Alternatively, a new message in the child or branch thread can be created as a copy of the selected message in the parent thread and this can be sent to the message server 300 with a request for a new branch thread to be created. In yet another embodiment, the branch thread is not yet created at the stage illustrated in FIG. 8. Instead the message displayed is simply a copy of the content of the selected message in the parent thread and the content is stored in association with the thread data as a pseudo header in the form of a first linked message.

In a lower region of the display screen of FIG. 8 the message input region 440 is displayed with a user entered message ready to select the send button 445 to enter the first new message in the branch message thread.

When a user starts a branch they can select a subset of the users authorized to view and respond to the messages. In this way, a user can change the users entitled to participate in the new child or branch message thread that the user has created. Also, the user can select an image or icon to be used for the new branch or child message thread. In this example, the parent thread related to football and the icon was a football. Since this thread relates to an injury, an icon of a physiotherapist is selected by the user. The icon or image can be selected from prestored options or input from another source.

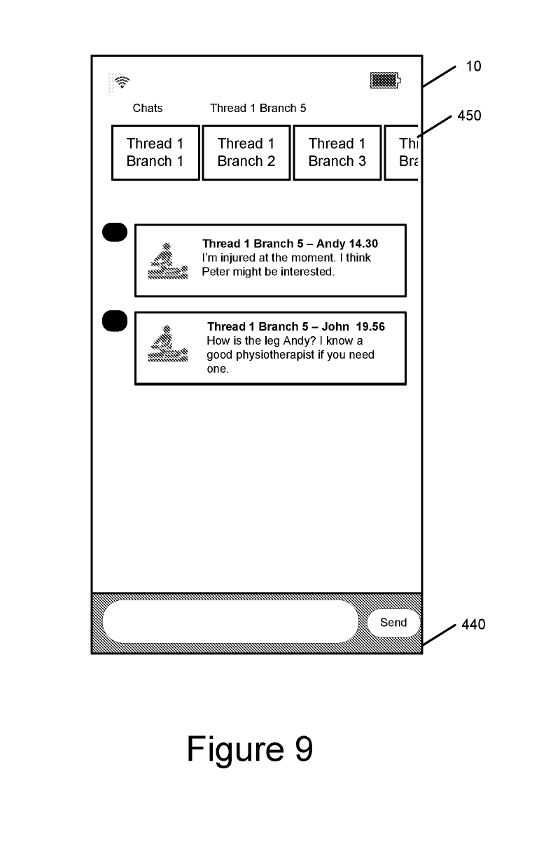

FIG. 9 illustrates the screen displayed by the display device 10 in response to the sending or posting of the message input by the user in the message input region 440 in FIG. 8. When the message is sent to the message server 300 it can in one embodiment be sent with a request for this new message to be the first in a new message thread. The message server 300 thus creates a new thread and returns a unique ID for the new thread and the new message. Theses IDs are received by the service server 200 and the structure data linking the ID of the new message thread to the ID of the parent thread and the ID of the selected message in the parent thread is created and stored in the user and structure database 204 and synchronized with the data in the user and structure database 104 so that the user's device has a copy locally received from the service server 200. In this way, the message server 300 need only perform conventional message service functions. The service server 200 performs the creation of the linking data structure to provide linking at the message level using both the message ID and the thread ID. In an alternative the IDs are received by the user's device 1 and the structure data linking the ID of the new message thread to the ID of the parent thread and the ID of the selected message in the parent thread is created and stored in the user and structure database 104 and synchronized with the data in the user and structure database 204 so that the service server 200 has a global copy of all of the data structures for all of the users.

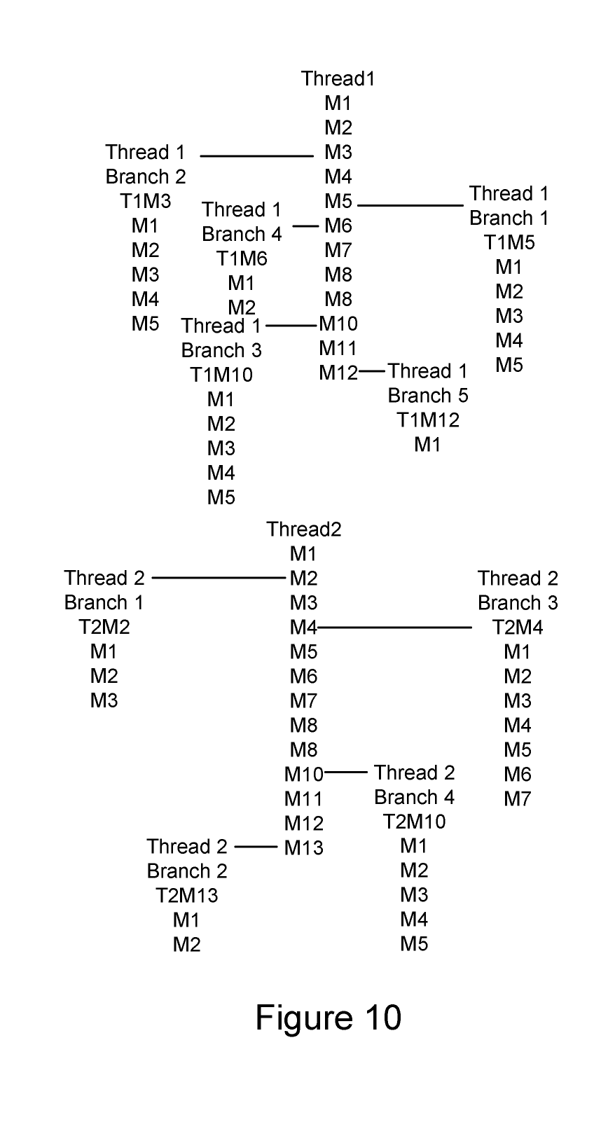

FIG. 10 schematically illustrates the data structure represented by the use of thread IDs and message IDs in the message server 300 and the service server 200.

FIG. 10 illustrates two parent message threads, Thread 1 and Thread 2. Thread 1 has 12 messages and from those messages 5 branches, Branch 1 to Branch 5. Each branch message thread has a varying numbers of messages. It should be noted that the branches are not sequential in order with the messages. In this embodiment, branch 1 was created from message 5 in the parent thread, branch 2 was then created when the user scrolled back up to message 3 in the parent thread, branch 3 was created from message 10 in the parent thread, branch 4 was created when the user scrolled back to message 6 in the parent thread, and branch 5 was created from message 12 in the parent thread. A similar structure can be seen for Thread 2 and its child threads, branch 1 to branch 4.

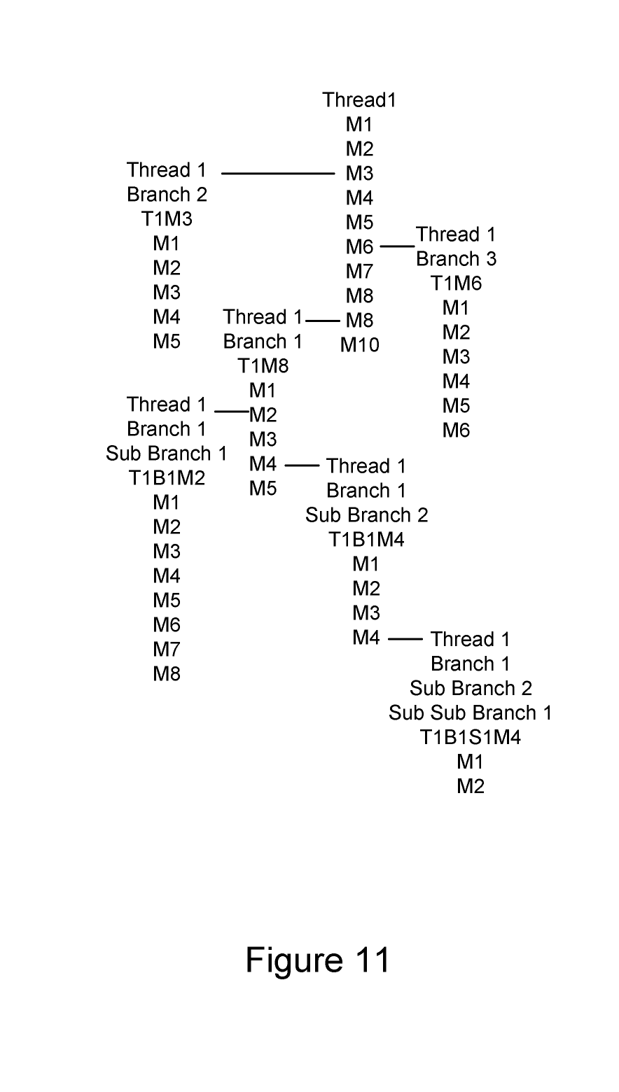

FIG. 11 schematically illustrates a data structure represented by the use of thread IDs and message IDs in the message server 300 and the service server 200 in another embodiment. In this embodiment, the child message threads or branches are not restricted to being at two levels as in the embodiment of FIG. 10. In this embodiment child message threads can themselves have child message threads and hence they become parent message threads for their child message threads. FIG. 11 illustrates a possible branching from Thread 1 to Thread 1 Branch 1, to Sub-branch 2 to sub-sub-branch 1 (a four level hierarchy). It can hence be seen that the use of message IDs and message thread IDs stored in a relationship manner by the service server 200 enables a hierarchical branching structure to be represented in the data and hence created on the screen display so that a user can navigate from message to message, not just along a thread but from a child thread to a parent thread and vice versa. In this way, a user can navigate and traverse the hierarchical data representation. In order to do this, links from a child message thread to a parent message thread can be displayed in a similar manner to the selectable link 470 displayed in FIG. 7 used to display a link from a parent message thread to a child message thread.

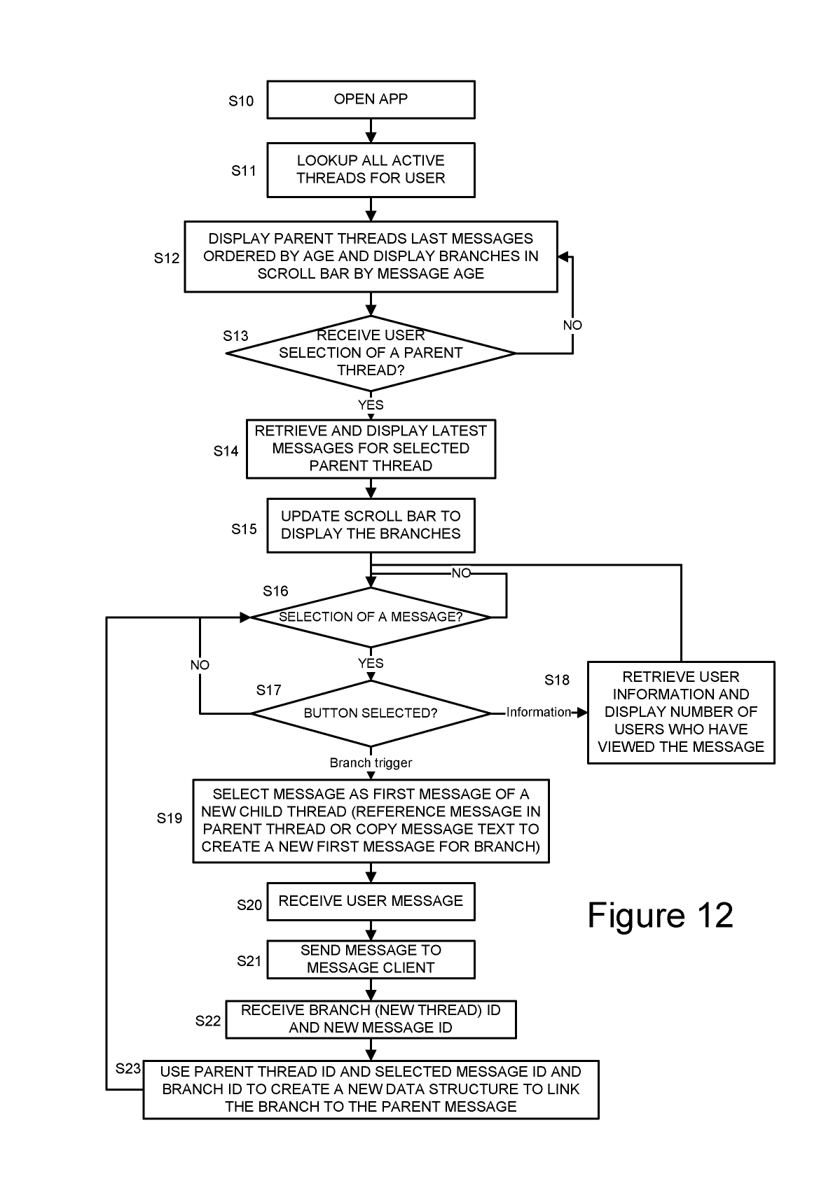

FIG. 12 is a flow diagram illustrating the process according to one embodiment.

In step S10, a user selects to open the app on the user's device 10 and hence the user's device runs the program code 21 to implement the modules illustrated in FIG. 2. In step S11 all active threads for the user are looked-up by identifying user IDs associated with thread IDs. Threads with no parents IDs in the structure data are identified as the parent or root message threads. In step S12 the most recent message for each parent thread is displayed ordered by age and a scrollable bar identifying branch threads from the parent message threads is displayed as illustrated in FIG. 3.

The process then awaits receipt of a selection of a parent thread by the user in step S1. When a selection of a parent thread is received in step S13, in step S14 the latest or newest messages for the selected parent thread are retrieved from the message database 102 and displayed and in step S15 the scroll bar is updated to display the branches for the selected parent thread as illustrated in FIG. 4.

The process awaits receipt of selection of a message in step S16. When a message is selected in step S16 the process then awaits selection of the information button 465 or the branch trigger button 460 in step S17, as illustrated in FIG. 5. If the information button 465 is selected in step S17, in step S18 user information is retrieved to display the number of users who have viewed the selected message, as illustrated in FIG. 6, and the process returns to step S16. If the branch trigger button 460 is selected in step S17, a link is displayed next to the message as illustrated in FIG. 7 and as shown in FIG. 8, the selected message is selected as the first message of the new child message thread. The selected message can either be linked to the new child thread so that no new message copy is created or a copy of the message can be created. In step S20 a message is received from a user input and in step S21 the message is sent to the message client 301 of the message server to create a new thread with a thread ID and a message ID for the message. In step S22 the new thread ID and the new message ID are received and in step S23 the parent message thread ID, the selected message ID and the branch or child message thread ID are used in the service server 200 (or in the user's device 1) to create a data structure to link the branch or child message thread to the selected message in the parent message thread. The process then returns to step S16 to await the selection of a message.

In an embodiment, the user module in the service server provides a communications interface to control the sending and receiving of messages to and from the user's device and it serves as a processor to create the data structure to link the branch to a message in a parent thread. The message module in the service server also acts as a communications interface to the sending and receiving of messages to and from the message server.

In one embodiment a carrier medium such as a non-transient storage medium can store program code for controlling a processor of a digital electronic device to carry out the method, or a transient medium carrying program code can control a processor of a digital electronic device to carry out the method. Embodiments can be implemented in programmable digital logic that implements computer code. The code can be supplied to the programmable logic, such as a processor or microprocessor, on a carrier medium. One such form of carrier medium is a transient medium i.e. a signal such as an electrical, electromagnetic, acoustic, magnetic, or optical signal. Another form of carrier medium is a non-transitory medium that carries or stores the code, such as a solid-state memory, magnetic media (hard disk drive), or optical media (compact disc (CD) or digital versatile disc (DVD)).

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

1. A messaging apparatus for sending and receiving messages organized in threads, the messaging apparatus comprising:
a communications interface to receive messages posted by a group of one or more users to at least one message thread and to post messages to the at least one message thread for access by the group of users, the communications interface being adapted to send the messages to and received the messages from a server;
a display to display messages posted by one or more users of the group of users to the at least one message thread;
a user input device to receive a user selection of a message in a parent message thread for the creation of a child message thread, the message having a message identifier, the user input device being adapted to receive a new message to post to the child message thread; and
a message processor to post the new message by controlling the communications interface to send the new message to the server to be accessible by the group of users in the child message thread, the message processor being adapted to create or receive a link between the message identifier for the selected message in the parent message thread and a new message identifier for the new message in the child message thread;
wherein the display is adapted to display the new message in the child message thread.

2. The messaging apparatus according to claim 1, wherein the message processor is adapted to receive user selections from the user input device to allow a user to navigate displayed messages from the parent message thread and the child message thread using said link between the message identifiers.

3. The messaging apparatus according to claim 1, herein the display is adapted to display the content of the selected message in the parent thread as a first message of the child thread.

4. The messaging apparatus according to claim 1, wherein the message processor is adapted to create the child message thread by controlling the communications interface to send to the server a request for a new message thread to be created with the new message and to receive the child thread identifier and a new message identifier.

5. The messaging apparatus according to claim 1, wherein:
the parent message thread has a parent message thread identifier and the child message thread has a child message thread identifier;
the message processor is adapted to create or receive the link between the message identifier for the selected message in the parent message thread and the new message identifier for the new message by creating or receiving a link between the message identifier for the selected message in the parent message thread and the child message thread identifier associated with the new message; and
the message processor is adapted to store the links between the child thread identifiers and the message identifiers of the parent message threads identifiers.

6. The messaging apparatus according to claim 5, wherein:
the user input device is adapted to receive a user selection of a message in a child message thread for the creation of a further child message thread, the child thread identifier becoming a parent thread identifier for the further child message thread and the message having a message identifier, the user input device being adapted to receive a new message to post to the further child message thread, the further child message thread having a further child message thread identifier;
the message processor is adapted to create or receive a link between the further child thread identifier and the child thread identifier and message identifier for the selected message;
the message processor is adapted to post the new message by controlling the communications interface to send the new message to the server to be accessible by the group of users in the further child message thread; and
the display is adapted to display the new message in the further child message thread.

7. The messaging apparatus according to claim 6, wherein the message processor is adapted to store the links between the child thread identifiers and the message identifiers of the parent message threads and the parent message thread identifiers in a hierarchically organized relationship.

8. The messaging apparatus according to claim 5, wherein the display is adapted to display messages of the child message thread and a navigable link to a message in the parent message thread having a message identifier linked to the child thread identifier, the user input device is adapted to allow a user to select to navigate to the message in the parent message thread having a message identifier linked to the child thread identifier, and the display is adapted to display the messages of the parent message thread at a position in the parent message thread of the message having a message identifier linked to the child thread identifier.

9. The messaging apparatus according to claim 5, wherein the display is adapted to display messages of the parent message thread with a link to a child message thread from a message, the user input device is adapted to allow a user to select the message in the parent message thread to navigate to the messages in the child message thread, and the display is adapted to display the messages of the child message thread.

10. The messaging apparatus according to claim 1, wherein the message processor is adapted to receive an input from the user input device to restrict access to messages posted in a child message thread, and to control the communications interface to send information to the server to restrict access to the messages of the child message thread to a sub-group of users.

11. The messaging apparatus according to claim 1, wherein the message processor is adapted to receive an input from the user input device to change or input an image or icon to be displayed with the messages posted to a child thread.

12. The messaging apparatus according to claim 1, wherein the message processor is adapted to receive an input from the user input device to select a said group of users to access and share posted messages from a plurality of groups of users, each group of users being associated with a persona of the user.

13. A method of sending and receiving messages organized in threads, the method comprising:
receiving messages posted by a group of one or more users to at least one message thread and posting messages to the at least one message thread for access by the group of users, the messages being sent to and received from a server;
displaying messages posted by one or more users of the group of users to the at least one message thread;
receiving a user selection of a message in a parent message thread for the creation of a child message thread, the message having a message identifier;
receiving a new message to post to the child message thread;
posting the new message by sending the new message to the server to be accessible by the group of users in the child message thread;
creating or receiving a link between the message identifier for the selected message in the parent message thread and a new message identifier for the new message in the child message thread; and
displaying the new message in the child message thread.

14. The method according to claim 13, wherein user selections are received to allow a user to navigate displayed messages from the parent message thread and the child message thread using said link between the message identifiers.

15. The method according to claim 13, wherein the content of the selected message is displayed in the parent thread as a first message of the child thread.

16. The method according to claim 13, wherein the child message thread is created by sending to the server a request for a new message thread to be created with the new message and receiving the child thread identifier and a new message identifier.

17. The method according to claim 13, wherein:
the parent message thread has a parent message thread identifier and the child message thread has a child message thread identifier;
the link between the message identifier for the selected message in the parent message thread and the new message identifier for the new message is created or received by creating or receiving a link between the message identifier for the selected message in the parent message thread and the child message thread identifier associated with the new message; and
the method including storing the links between the child thread identifiers and the message identifiers of the parent message threads identifiers.

18. The method according to claim 17, including:
receiving a user selection of a message in a child message thread for the creation of a further child message thread, the child thread identifier becoming a parent thread identifier for the further child message thread and the message having a message identifier;
receiving a new message to post to the further child message thread, the further child message thread having a further child message thread identifier;
creating or receiving a link between the further child thread identifier and the child thread identifier and message identifier for the selected message;
posting the new message by sending the new message to the server to be accessible by the group of users in the further child message thread; and
displaying the new message in the further child message thread.

19. The method according to claim 18, including storing the links between the child thread identifiers and the message identifiers of the parent message threads and the parent message thread identifiers in a hierarchically organized relationship.

20. The method according to claim 17, including displaying messages of the child message thread and a navigable link to a message in the parent message thread having a message identifier linked to the child thread identifier, receiving a user selection to navigate to the message in the parent message thread having a message identifier linked to the child thread identifier, and displaying the messages of the parent message thread at a position in the parent message thread of the message having a message identifier linked to the child thread identifier.

21. The method according to claim 17, including displaying messages of the parent message thread with a link to a child message thread from a message, receiving a user selection of the message in the parent message thread to navigate to the messages in the child message thread, and displaying the messages of the child message thread.

22. The method according to claim 13, including receiving an input to restrict access to messages posted in a child message thread, and sending information to the server to restrict access to the messages of the child message thread to a sub-group of users.

23. The method according to claim 13, including receiving an input to change or input an image or icon to be displayed with the messages posted to a child thread.

24. The method according to claim 13, including receiving an input to select a said group of users to access and share posted messages from a plurality of groups of users, each group of users being associated with a persona of the user.

25. A messaging apparatus for viewing messages organized in threads, the messaging apparatus comprising:
a communications interface to receive messages posted by a group of one or more users to message threads, the communications interface being adapted to receive the messages from a server, the message threads including a parent message thread and a child message thread and a link between a message identifier for a message in the parent message thread and a message identifier for a message in the child message thread;
a display to display messages posted by one or more users of the group of users to the message threads;
a user input device to receive a user navigation input to navigate the displayed messages in the message threads; and
a message processor to receive user navigation input from the user input device to allow a user to navigate displayed messages from the parent message thread and the child message thread using said link between the message identifiers.

26. The messaging apparatus according to claim 25, wherein:
the parent message thread has a parent message thread identifier and the child message thread has a child message thread identifier;
the link between the message identifier for the selected message in the parent message thread and the new message identifier for the new message comprises a link between the message identifier for the message in the parent message thread and the child message thread identifier; and
the message processor is adapted to store the links between the child thread identifiers and the message identifiers of the parent message threads identifiers.

27. A method of viewing messages organized in threads, the messaging method comprising:
receiving messages posted by a group of one or more users to message threads from a server, the message threads including a parent message thread and a child message thread and a link between a message identifier for a message in the parent message thread and a message identifier for a message in the child message thread;
displaying messages posted by one or more users of the group of users to the message threads;
receiving a user navigation input to navigate the displayed messages in the message threads; and
receiving user navigation input from the user input device to allow a user to navigate displayed messages from the parent message thread and the child message thread using said link between the message identifiers.

28. The method according to claim 27, wherein:
the parent message thread has a parent message thread identifier and the child message thread has a child message thread identifier;
the link between the message identifier for the selected message in the parent message thread and the new message identifier for the new message comprises a link between the message identifier for the message in the parent message thread and the child message thread identifier; and
the method including storing the links between the child thread identifiers and the message identifiers of the parent message threads identifiers.

29. (canceled)

30. A method of configuring a client device as a messaging apparatus having a communications interface, a display device, a user input device and a message processor, the method comprising:
transmitting computer program code to the client device to cause the client device to be configured as the messaging apparatus
for sending and receiving messages organized in threads, the messaging apparatus comprising:
a communications interface to receive messages posted by a group of one or more users to at least one message thread and to post messages to the at least one message thread for access by the group of users, the communications interface being adapted to send the messages to and received the messages from a server;
a display to display messages posted by one or more users of the group of users to the at least one message thread;
a user input device to receive a user selection of a message in a parent message thread for the creation of a child message thread, the message having a message identifier, the user input device being adapted to receive a new message to post to the child message thread; and
a message processor to post the new message by controlling the communications interface to send the new message to the server to be accessible by the group of users in the child message thread, the message processor being adapted to create or receive a link between the message identifier for the selected message in the parent message thread and a new message identifier for the new message in the child message thread;
wherein the display is adapted to display the new message in the child message thread.

31. A non-transient storage medium storing processor implementable code for controlling a processor to send and receive messages organized in threads by:
receiving messages posted by a group of one or more users to at least one message thread and posting messages to the at least one message thread for access by the group of users, the messages being sent to and received from a server;
displaying messages posted by one or more users of the group of users to the at least one message thread;
receiving a user selection of a message in a parent message thread for the creation of a child message thread, the message having a message identifier;
receiving a new message to post to the child message thread;
posting the new message by sending the new message to the server to be accessible by the group of users in the child message thread;
creating or receiving a link between the message identifier for the selected message in the parent message thread and a new message identifier for the new message in the child message thread; and
displaying the new message in the child message thread.

32. A server apparatus for sending and receiving messages to and from user's messaging apparatuses, the server apparatus comprising:
a communications interface to receive messages posted by a group of one or more users to at least one message thread and to post messages to the at least one message thread for access by the group of users, the communications interface being adapted to send the messages to and receive the messages from the user's messaging apparatuses;
a message processor to receive a new message from a user's messaging apparatus to be posted to be accessible by the group of users in a child message thread, the message processor being adapted to create a link between a message identifier for the selected message in a parent message thread and a new message identifier for the new message in the child message thread or receive from the user's messaging device a link between a message identifier for the selected message in a parent message thread and a new message identifier for the new message in the child message thread; and
a store to store the link;
wherein the communications interface is adapted to send the link to the user's messaging apparatuses to enable display of a link between a child message thread and a message in a parent message thread.

33. The server apparatus according to claim 32, wherein the communications interface is further connected to a message server and is adapted to receive messages from the message server posted by a group of one or more users to at least one message thread and to post messages to the message server to the at least one message thread for access by the group of users, and the message processor being adapted to create the child message thread by sending to the message server a request for a new message thread to be created with the new message and to receive the child thread identifier and a new message identifier.

34.-36 (canceled)

37. A non-transient storage medium storing processor implementable code for controlling a processor to view messages organized in threads by:
receiving messages posted by a group of one or more users to message threads from a server, the message threads including a parent message thread and a child message thread and a link between a message identifier for a message in the parent message thread and a message identifier for a message in the child message thread;
displaying messages posted by one or more users of the group of users to the message threads;
receiving a user navigation input to navigate the displayed messages in the message threads; and
receiving user navigation input from the user input device to allow a user to navigate displayed messages from the parent message thread and the child message thread using said link between the message identifiers.
